(19) United States
(12) Patent Application Publication
(10) Pub. No.: US 2011/0292871 A1
(43) Pub. Date: Dec. 1, 2011

(54) Wireless Attachment To Multiple Radio Access Networks At The Same Time

(76) Inventors: Tom Chin, San Diego, CA (US); Guangming Shi, San Diego, CA (US); Kuo-Chun Lee, San Diego, CA (US)

(21) Appl. No.: 12/883,951

(22) Filed: Sep. 16, 2010

Related U.S. Application Data
(60) Provisional application No. 61/348,137, filed on May 25, 2010.

(51) Int. Cl. H04W 60/04; H04W 88/06

(52) U.S. Cl. 370/328

(57) ABSTRACT

Wireless communication within an area covered by multiple radio access networks may be accomplished where a user equipment (UE) is configured for first and second radio access networks. The UE attaches to the first radio access network, and, while maintaining the attachment to the first radio access network, also attaches to the second radio access network.

### CROSS REFERENCE TO RELATED APPLICATION

This application claims the benefit of U.S. provisional patent application No. 61/348,137 filed May 25, 2010, in the names of CHIN et al., the disclosure of which is expressly incorporated herein by reference in its entirety.

### BACKGROUND

1. Field

Aspects of the present disclosure relate generally to wireless communication systems, and more particularly, to wireless attachment to multiple radio access networks at the same time.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Packet Access (HSPA), which provides higher data transfer speeds and capacity to associated UMTS networks. HSPA is a collection of two mobile telephony protocols, High Speed Downlink Packet Access (HSDPA) and High Speed Uplink Packet Access (HSUPA), that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

In an aspect of the disclosure, a method for wireless communication includes detecting first and second radio access networks, attaching to the first radio access network, and attaching to the second radio access network while maintaining the attachment to the first radio access network.

In a further aspect of the disclosure, a UE configured for wireless communication includes means for detecting first and second radio access networks, means for attaching to the first radio access network, and means for attaching to the second radio access network while maintaining the attachment to the first radio access network.

In another aspect of the disclosure, a computer program product includes a computer-readable medium having program code recorded thereon. The program code includes code to detect first and second radio access networks, code to attach to the first radio access network, and code to attach to the second radio access network while maintaining the attachment to the first radio access network.

In a further aspect of the disclosure, a UE configured for wireless communication includes at least one processor and a memory coupled to the processor. The processor or processors are configured to detect first and second radio access networks, to attach to the first radio access network, and to attach to the second radio access network while maintaining the attachment to the first radio access network.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a diagram illustrating a mixed network that includes coverage areas of a TD-SCDMA network and a GSM network.

FIG. 5A is a block diagram illustrating a dual mode UE that may be used in implementing one aspect of the present disclosure.

FIG. 5B is a block diagram illustrating another dual mode UE that may be used in implementing one aspect of the present disclosure.

FIG. 6 is a functional block diagram illustrating example blocks executed to implement one aspect of the present disclosure.

FIG. 7 is a call flow diagram illustrating a call flow occurring with a UE configured according to one aspect of the present disclosure.

FIG. 8 is a call flow diagram illustrating a call flow occurring with a UE configured according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

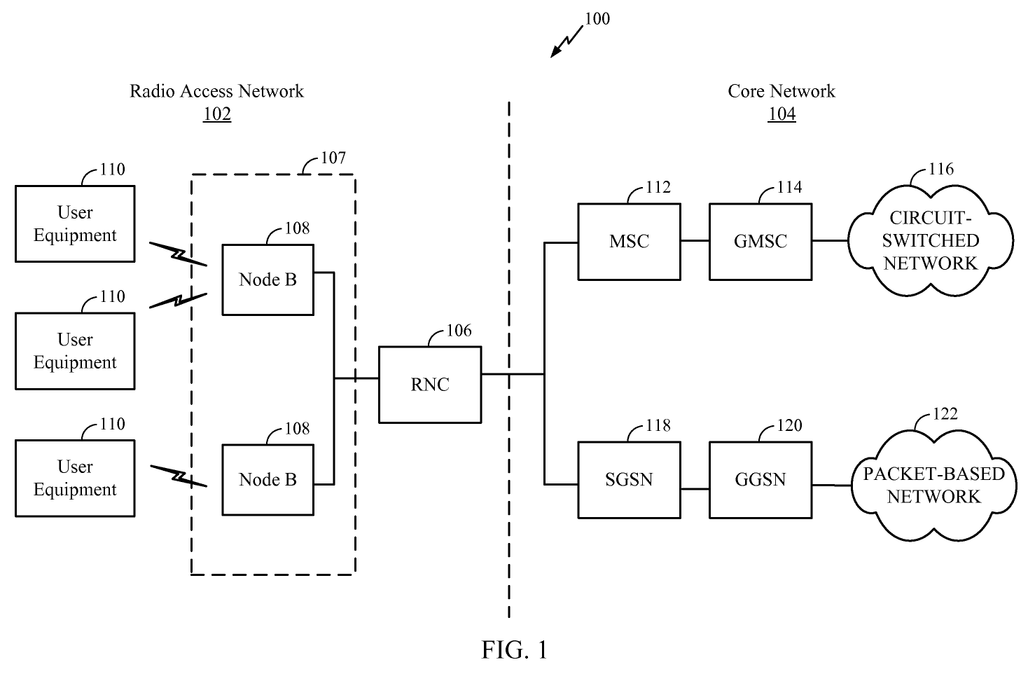

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

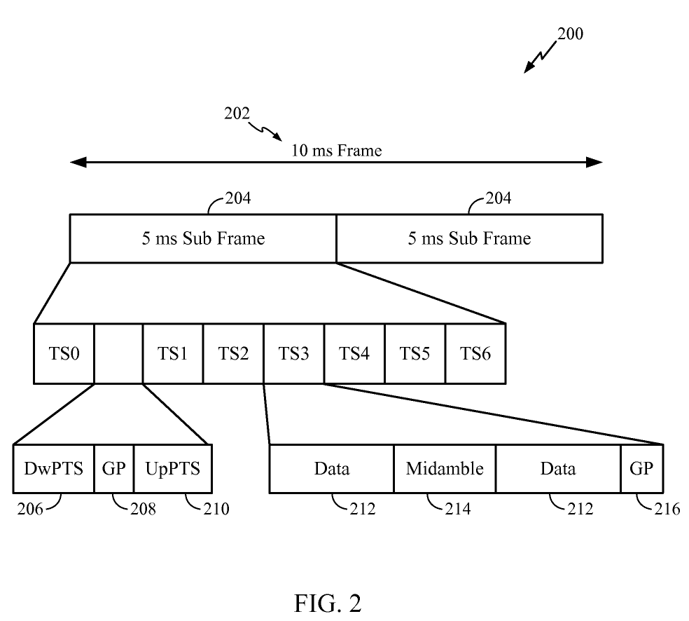

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

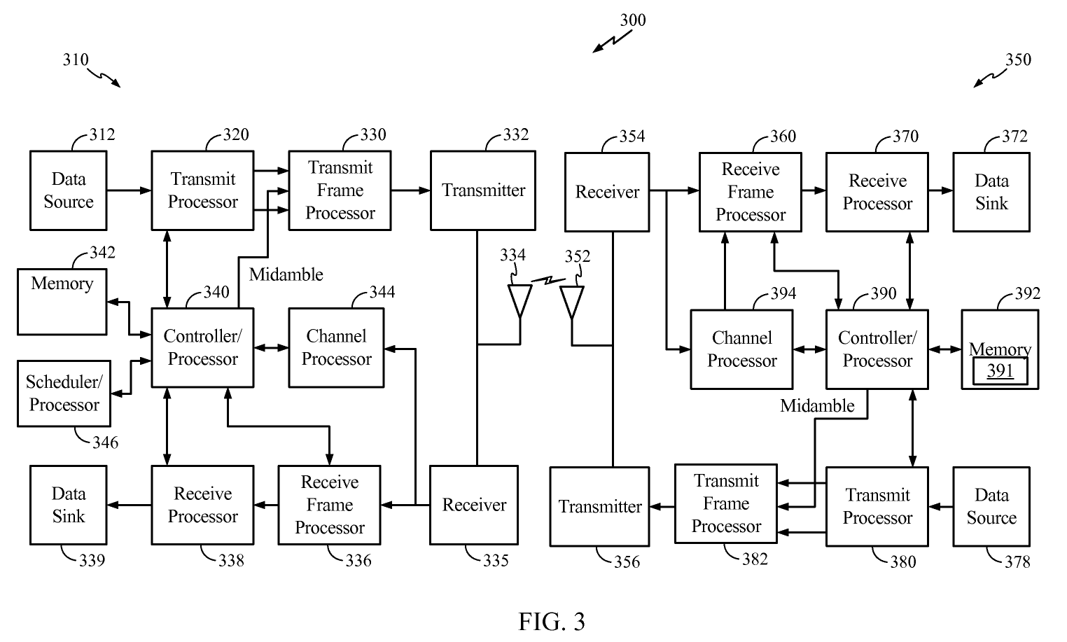

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a channel monitor module 391 which, when executed by the controller/processor 390, configures the UE 350 to adjust its control channel monitoring based on a physical layer indication received from a node B. A scheduler/processor 346 at the node B 310 may be used to allocate resources to the UEs and schedule downlink and/or uplink transmissions for the UEs.

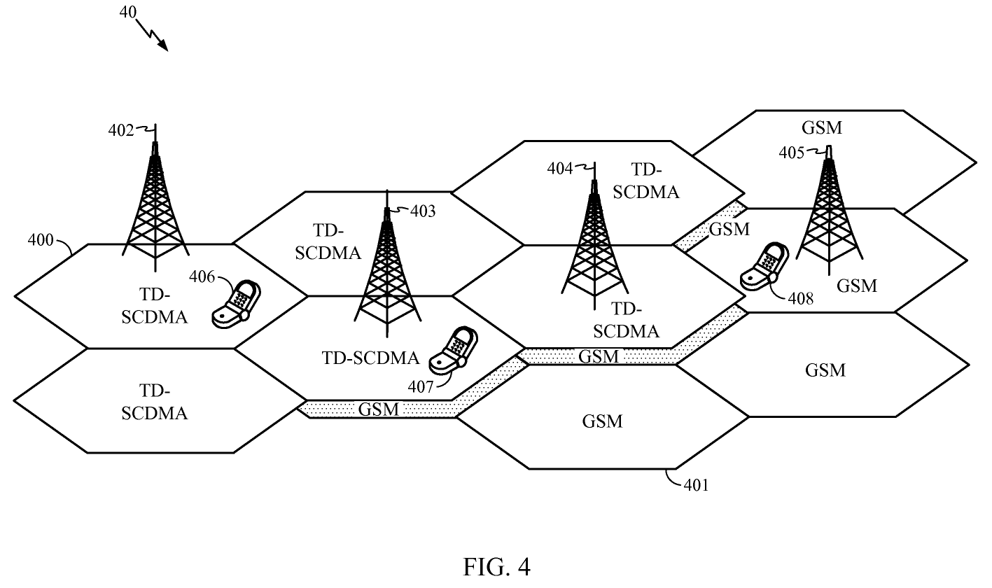

In the migration TD-SCDMA radio access technology, UEs may encounter areas that have both GSM and TD-SCDMA coverage. However, there will be some locations where there is only coverage through a GSM network and no TD-SCDMA network coverage. There will also be some locations where there is only coverage through a TD-SCDMA network and no GSM network coverage. FIG. 4 is a diagram illustrating a mixed network 40 that includes coverage areas of a TD-SCDMA network 400 and a GSM network 401. The mixed network 40 includes areas where there is dual coverage between the TD-SCDMA network 400 and the GSM network 401 and other areas where there is only coverage of the individual networks. The base stations 402-405 operate node Bs for the TD-SCDMA network 400 and the GSM network 401. For example, the base station 402 may operate a single node B for the TD-SCDMA network 400, while the base station 405 may operate a single node B for the GSM network 401. The base stations 403 and 404 may each operate two node Bs, one for the TD-SCDMA network 400 and the other for the GSM network 401. UEs, such as the UE 407 within the coverage area of base station 403, may connect for communication through both or either of the TD-SCDMA network 400 and the GSM network 401, while UEs such as the UEs 406 and 408 within the coverage areas of base stations 402 and 405, respectively, would only be able to connect for communication through either the TD-SCDMA network 400 (for UE 406 through the base station 402) or the GSM network 401 (for UE 408 through the base station 405).

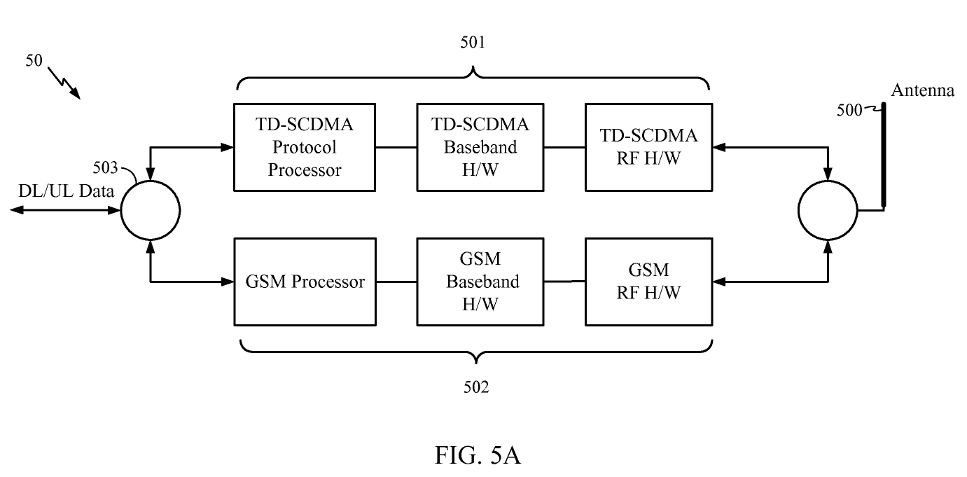

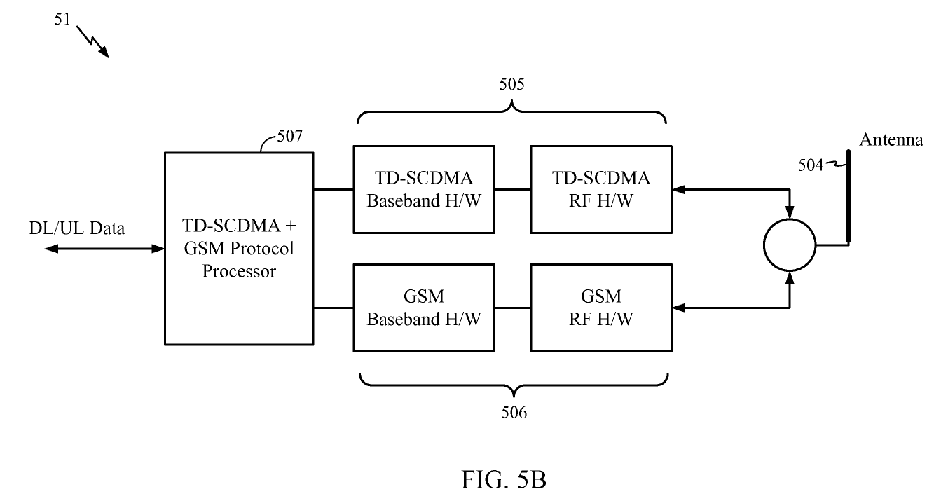

In order for a UE, such as the UE 407, to connect to both the TD-SCDMA network 400 and the GSM network 401, the UE includes both hardware and software enabling it to establish communication with the protocols of both TD-SCDMA and GSM technologies. FIG. 5A is a block diagram illustrating a dual mode UE 50 that may be used in implementing one aspect of the present disclosure. Signals from and to any protocol are received and transmitted by the UE 50 through an antenna 500. TD-SCDMA protocol signals are then processed through a TD-SCDMA process section 501, which includes hardware and software specifically designed for processing communications using TD-SCDMA protocols. Similarly, GSM protocol signals are processed through a GSM process section 502, which includes hardware and software specifically designed for processing communications using GSM protocols. The resulting processed uplink and downlink data is left in a common protocol that may be further processed in a common processing section 503.

FIG. 5B is a block diagram illustrating a dual mode UE 51 that may be used in implementing one aspect of the present disclosure. The dual mode UE 51 also receives and transmits signals using an antenna 504. In contrast to the dual mode UE 50 (FIG. 5A), the dual mode UE 51 employs independent RF chain and modem baseband hardware (H/W) and software in a TD-SCDMA processing block 505 and a GSM processing block 506, but shares a single processor 507 for protocol stack processing. Both types of UE, the UE 50 (of FIG. 5A) and the UE 51 (of FIG. 5B), may connect to either or both TD-SCDMA and GSM networks for communications, either separately or at the same time.

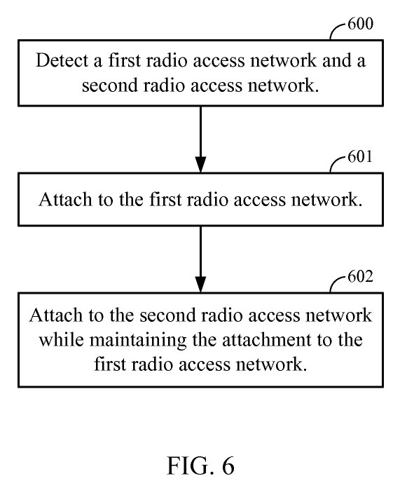

In existing operations, dual mode UEs are generally able to attach to and register services with a single radio access network. For example, with reference to FIG. 4, the UE 407 would either attach and register all service call types with the GSM network 401 or the TD-SCDMA network 400. However, in aspects of the present disclosure, such a UE may attach to both networks at the same time. FIG. 6 is a functional block diagram illustrating example blocks executed to implement one aspect of the present disclosure. In block 600, a first and second radio access network are detected. Signaling protocols and procedures are used to attach to the first radio access network in block 601. In block 602, additional signaling protocols and procedures are used to attach to the second radio access network while maintaining attachment to the first radio access network.

By attaching to both radio access networks at the same time, a UE may be configured to register particular call type services with any one of the attached networks at any given time. Thus, certain service types may be selected for certain radio access networks based on a variety of criteria, including strength of signal or even the level of efficiency that a particular radio access network handles for that type of call service. For example, circuit-switched voice calls are often handled more efficiently by a GSM network when compared to voice calls handled by a TD-SCDMA network. Similarly, packet-switched data calls are often handled more efficiently by a TD-SCDMA network when compared to data calls handled by a GSM network.

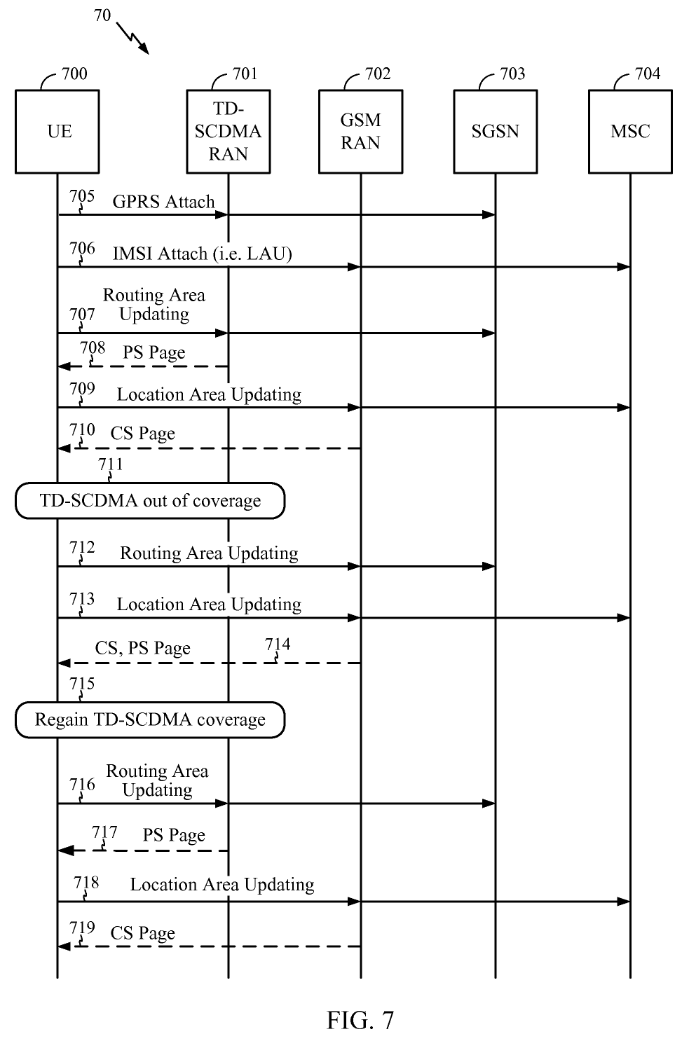

FIG. 7 is a call flow diagram illustrating a call flow 70 occurring with a UE 700 configured according to one aspect of the present disclosure. The UE 700 is located in an area covered by both a TD-SCDMA radio access network (RAN) 701 with its related serving GPRS support node (SGSN) 703 and a GSM network 702 with its related mobile switching center (MSC) 704. The UE 700 is a dual mode UE that includes hardware and software such as those illustrated in one of FIG. 5A or 5B, and is capable of processing communication signals to or from either of the TD-SCDMA network 701 and the GSM network 702 at the same time. At time 705, the UE 700 attaches to the TD-SCDMA network 701 through the GPRS attachment procedure with the TD-SCDMA network 701 and the SGSN 703. While attaching to the TD-SCDMA network 701, the UE 700 also begins attachment procedures with the GSM network 702 and the MSC 704 at time 706. The UE 700 will attach and register services with the TD-SCDMA network 701 and the GSM network 702 through location area updating (LAU) (for the GSM network 702) and routing area updating (RAU) (for the TD-SCDMA network 701). The LAU and RAU messaging are performed regularly for updating each respective network of the location or address of the UE 700. The UE 700 first begins its LAU messaging when attaching to the GSM network 702 along with its international mobile subscriber identity (IMSI) messaging exchanged during the attachment procedures. At time 707, the UE 700 also transmits RAU messages to the TD-SCDMA network 701 and the SGSN 703.

In attaching to both the TD-SCDMA network 701 and the GSM network 702, the UE 700 registers packet-switched call types for handling by the TD-SCDMA network 701 and registers circuit-switched call types for handling by the GSM network 702. At time 708, a packet-switched page is received by the UE 700 from the TD-SCDMA network 701. The UE 700 registered packet-switched services with the TD-SCDMA network 701 during the RAU messages transmitted at time 707. Thus, the TD-SCDMA network 701 received the packet-switched page, and forwarded that page to the UE 700 to handle the packet-switched call through the TD-SCDMA network 701. At time 709, the UE 700 performs additional LAU messaging and registers all circuit-switched services with the GSM network 702. Thus, when the GSM network 702 receives a circuit-switched page for the UE 700, it transmits the circuit-switched page to the UE 700 at time 710 indicating for the UE 700 to handle the circuit-switched call through the GSM network 702.

As the UE 700 moves through various coverage areas, the UE 700, at time 711, enters a location where it is no longer within the coverage of the TD-SCDMA network 701. When this coverage is dropped, the UE 700 immediately transmits a RAU message at time 712, updating the GSM network 702 of its position/location and also registering for packet-switched call types with the GSM network 702. Depending on the UE status (such as a change in location) the UE may also transmit an LAU message at time 713 updating the GSM network 702 of its position/location and also re-registering for circuit-switched call types with the GSM network 702. Thus, when the GSM network 702 receives both packet-switched and circuit-switched pages addressed to the UE 700, it forwards both page types to the UE 700 at time 714. These pages indicate to the UE 700 to handle both types of calls through the GSM network 702.

As the UE 700 re-enters a coverage area for the TD-SCDMA network 701 at time 715, a new RAU message is immediately transmitted to the TD-SCDMA network 701 and the SGSN 703 at time 716 indicating the new location/position of the UE 700 and re-registering for packet-switched services through the TD-SCDMA network 701. Thus, as new packet-switched service pages are received at the TD-SCDMA network 701, it forwards those pages to the UE 700 at time 717 as an indication to handle the new packet-switched call through the TD-SCDMA network 701. The routine additional LAU messages, at time 718, also update the GSM network 702 and the MSC 704 of the location/position of the UE 700 and also register for circuit-switched services to be handled through the GSM network 702. Accordingly, when the GSM network 702 receives new circuit-switched pages, it forwards those pages to the UE 700 at time 719 indicating to the UE 700 to handle the new circuit-switched calls through the GSM network 702.

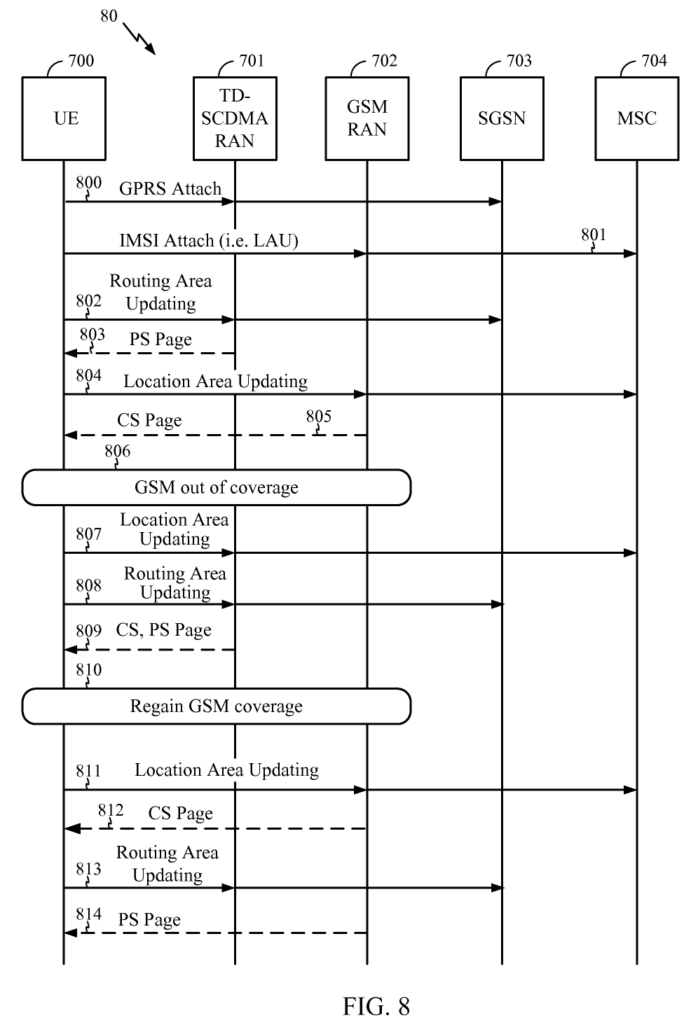

Similar processing may occur as a UE drops and enters GSM coverage areas as well. FIG. 8 is a call flow diagram illustrating a call flow 80 occurring with a UE 700 configured according to one aspect of the present disclosure. At times 800 and 801, the UE 700 attaches to both the TD-SCDMA network 701 and the GSM network 702 at the same time. In the RAU messaging, at time 802, the UE 700 registers a first call type service with the TD-SCDMA network 701 and the SGSN 703. The TD-SCDMA network 701 then begins forwarding pages of that call type to the UE 700 at time 803. Similarly, in the LAU messaging, at time 804, the UE 700 updates its location/position with the GSM network 702 and also registers another call type service with the GSM network 702 and the MSC 704. Thus, the GSM network 702 begins forwarding pages for that other call type to the UE 700 at time 805.

As the UE 700 moves, it falls out of coverage of the GSM network 702 at time 806. The UE 700 immediately transmits a new LAU message at times 807, updating the TD-SCDMA network 701 of its location/position and also updating registration for the circuit-switched call types with the TD-SCDMA network 701. Depending on the UE status (such as a change in location) the UE may also transmit an RAU message at time 808 updating the TD-SCDMA network 701 of its position/location and also re-registering for packet-switched call types with the TD-SCDMA network 701. Therefore, when the TD-SCDMA network 701 receives pages for the UE 700 in those call types, at time 809, it will forward those pages to the UE 700 indicating for the UE 700 to handle calls of those types now all with the TD-SCDMA network 701. At time 810, when the UE 700 re-gains coverage of the GSM network 702, the UE 700 immediately transmits LAU messages, at time 811, updating location/position and also re-registering the particular call type with the GSM network 702 and the MSC 704. Thus, the GSM network 702 will forward pages of this call type to the UE 700 at time 812. The UE 700 also performs the routine continued RAU messaging at time 813, to update the TD-SCDMA network 701 of its location/position and to register with the other call type. Therefore, at time 814, the UE 700 will receive forwarded pages from the TD-SCDMA network 701 of that call type.

In one configuration, the apparatus, for example the UE 350, for wireless communication includes means for detecting first and second radio access networks, means for attaching to the first radio access network, and means for attaching to the second radio access network while maintaining the attachment to the first radio access network. In one aspect, the aforementioned means may be the antennas 352, the receiver 354, the channel processor 394, the receive frame processor 360, the receive processor 370, the transmitter 356, the transmit frame processor 382, the transmit processor 380, the controller/processor 390, the memory 392, and the channel monitor module 391 configured to perform the functions recited by the aforementioned means. In another aspect, the aforementioned means may be a module or any apparatus configured to perform the functions recited by the aforementioned means.

Several aspects of a telecommunications system has been presented with reference to TD-SCDMA and GSM systems. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for wireless communication, comprising:
detecting a first radio access network and a second radio access network;
attaching to said first radio access network; and
attaching to said second radio access network while maintaining the attachment to said first radio access network.

2. The method of claim 1 wherein said first radio access network comprises a time division-synchronous code division multiple access (TD-SCDMA) network and said second radio access network comprises a Global System for Mobile Communication (GSM) network.

3. The method of claim 1 further comprising:
registering for a first call type with said first radio access network;
registering for a second call type with said second radio access network;
receiving a first call type page over said first radio access network; and
receiving a second call type page over said second radio access network.

4. The method of claim 3 further comprising:
losing coverage of said first radio access network; and
in response to said losing coverage, registering said first call type with said second radio access network.

5. The method of claim 3 further comprising:
losing coverage of said second radio access network; and
in response to said losing coverage, registering said second call type with said first radio access network.

6. The method of claim 3 wherein said first call type comprises a packet-switched call type, and said second call type comprises a circuit-switched call type.

7. A user equipment (UE) configured for wireless communication, comprising:
means for detecting a first radio access network and a second radio access network;
means for attaching to said first radio access network; and
means for attaching to said second radio access network while maintaining the attachment to said first radio access network.

8. The UE of claim 7 wherein said first radio access network comprises a time division-synchronous code division multiple access (TD-SCDMA) network and said second radio access network comprises a Global System for Mobile Communication (GSM) network.

9. The UE of claim 7 further comprising:
means for registering for a first call type with said first radio access network;
means for registering for a second call type with said second radio access network;
means for receiving a first call type page over said first radio access network; and
means for receiving a second call type page over said second radio access network.

10. The UE of claim 9 further comprising:
means for detecting a loss of coverage of said first radio access network; and
means, executable in response to said loss of coverage, for registering said first call type with said second radio access network.

11. The UE of claim 9 further comprising:
means for detecting a loss of coverage of said second radio access network; and
means, executable in response to said loss of coverage, for registering said second call type with said first radio access network.

12. The UE of claim 9 wherein said first call type comprises a packet-switched call type, and said second call type comprises a circuit-switched call type.

13. A computer program product, comprising:
a computer-readable medium having program code recorded thereon, said program code comprising:
program code to detect a first radio access network and a second radio access network;
program code to attach to said first radio access network; and
program code to attach to said second radio access network while maintaining the attachment to said first radio access network.

14. The computer program product of claim 13 wherein said first radio access network comprises a time division-synchronous code division multiple access (TD-SCDMA) network and said second radio access network comprises a Global System for Mobile Communication (GSM) network.

15. The computer program product of claim 13 wherein said program code further comprises:
program code to register for a first call type with said first radio access network;
program code to register for a second call type with said second radio access network;
program code to receive a first call type page over said first radio access network; and
program code to receive a second call type page over said second radio access network.

16. The computer program product of claim 15 wherein said program code further comprises:
program code to detect a loss of coverage of said first radio access network; and
program code, executable in response to detection of said loss of coverage, to register said first call type with said second radio access network.

17. The computer program product of claim 15 wherein said program code further comprises:
program code to detect a loss of coverage of said second radio access network; and
program code, executable in response to detection of said loss of coverage, to register said second call type with said first radio access network.

18. The computer program product of claim 15 wherein said first call type comprises a packet-switched call type, and said second call type comprises a circuit-switched call type.

19. A user equipment (UE) configured for wireless communication, comprising:
at least one processor; and
a memory coupled to said at least one processor, wherein said at least one processor is configured:
to detect a first radio access network and a second radio access network;
to attach to said first radio access network; and
to attach to said second radio access network while maintaining the attachment to said first radio access network.

20. The UE of claim 19 wherein said first radio access network comprises a time division-synchronous code division multiple access (TD-SCDMA) network and said second radio access network comprises a Global System for Mobile Communication (GSM) network.

21. The UE of claim 19 wherein said at least one processor is further configured:
to register for a first call type with said first radio access network;
to register for a second call type with said second radio access network;
to receive a first call type page over said first radio access network; and
to receive a second call type page over said second radio access network.

22. The UE of claim 21 wherein said at least one processor is further configured:
to detect a loss of coverage of said first radio access network; and
to register said first call type with said second radio access network in response to said detected loss of coverage.

23. The UE of claim 21 wherein said at least one processor is further configured:
to detect a loss of coverage of said second radio access network; and
to register said second call type with said first radio access network in response to said detected loss of coverage.

24. The UE of claim 21 wherein said first call type comprises a packet-switched call type, and said second call type comprises a circuit-switched call type.
